(19) United States
(12) Patent Application Publication
(10) Pub. No.: US 2003/0196072 A1
(43) Pub. Date: Oct. 16, 2003

(54) Digital signal processor architecture for high computation speed

(76) Inventors: Murali S. Chinnakonda, Austin, TX (US); Hebbalalu S. Ramagopal, Austin, TX (US); David Witt, Austin, TX (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/120,918

(22) Filed: Apr. 11, 2002

(51) Int. Cl. G06F 15/00

(52) U.S. Cl. 712/32

(57) ABSTRACT

A digital signal processor includes an instruction fetch unit for fetching and decoding instructions, a data cache, a memory, an execution unit, including a register file, for executing the instructions, and a load control unit for loading data from the data cache to the register file in response to instructions of a first instruction type and for loading data from the memory to the register file in response to instructions of a second instruction type. Instructions of the first instruction type may be microcontroller instructions, and instructions of the second instruction type may be digital signal processor instructions. The execution unit may include a microcontroller execution unit having a first number of pipeline stages for executing the microcontroller instructions and a digital signal processor execution unit having a second number of pipeline stages for executing the digital signal processor instructions.

### FIELD OF THE INVENTION

This invention relates to digital signal processors and, more particularly, to digital signal processor architectures that facilitate high speed digital signal processing computations.

### BACKGROUND OF THE INVENTION

A digital signal computer, or digital signal processor (DSP), is a special purpose computer that is designed to optimize performance for digital signal processing applications, such as, for example, fast Fourier transforms, digital filters, image processing, signal processing in wireless systems and speech recognition. Digital signal processor applications are typically characterized by real-time operation, high interrupt rates and intensive numeric computations. In addition, digital signal processor applications tend to be intensive in memory access operations and require the input and output of large quantities of data. Digital signal processor architectures are typically optimized for performing such computations efficiently.

Microcontrollers, by contrast, involve the handling of data but typically do not require extensive computation. Architectures that are optimized for DSP computations typically do not operate efficiently as microcontrollers, and microcontrollers typically do not perform well as digital signal processors. Nonetheless, applications frequently require both digital signal processor and microcontroller functionality.

The characteristics of microcontroller data access patterns include temporal and spatial locality, which is ideally found in a cache. Specifically, the latency of memory operations is important, and common instruction sequences, such as load-compare-branch, need to be executed with a short latency. Otherwise, the branch misprediction penalty is large. Pointer chasing, where a load is performed to a register and the load is subsequently used to form an address for another load (commonly referred to as load-to-load interlock or pointer chasing), also needs to be executed with a short latency. This is because the second load, whose address is dependent on the first load, stalls for a longer time. In an in-order processor, a stall stops the entire machine without any useful work being done. Therefore, a microcontroller demands a short pipeline memory architecture.

Digital signal processors perform repetitive computations on large data sets. These large data sets may be accessed only once in the form of a load-compute-store sequence where the load and store are executed many times and are to different addresses. Temporal locality doesn't apply to these data sets, since data is not being re-accessed. Spatial locality applies in a limited sense in that data access patterns tend to be non-sequential stride based. These features make caches non-optimal for DSP applications, since caches have the undesirable overhead of cache fills and copybacks. In a cache fill, the memory operation which produced a cache miss stalls the entire processor, waits for the data to come from memory and then the fill data is written to memory. In a typical example, four cycles may be required to write back 32 bytes of data, during which time that particular bank of memory is not available to the processor. A similar situation applies to copybacks. If data is rarely reused, i.e., poor temporal locality, then there is no advantage in bringing a line of memory into the cache in view of sparse spatial locality.

In one prior art approach, the cache is provided with SRAM capability. If the cache is programmed as SRAM, then there is no refill and copyback overhead. However, the SRAM size is very small compared to the large data set typically used in DSP computations. The burden of managing overlays, the swapping in and out of data from a larger SRAM using DMA, must be done by software. Getting to this work correctly in performance sensitive applications may be very difficult.

Digital signal processor designs may be optimized with respect to different operating parameters, such as computation speed, power consumption and ease of programming, depending on intended applications. Furthermore, digital signal processors may be designed for 16-bit words, 32-bit words, or other word sizes. A 32-bit architecture that uses a long instruction word and wide data buses and which achieves high operating speed is disclosed in U.S. Pat. No. 5,954,811, issued Sep. 21, 1999 to Garde. Notwithstanding very high performance, the disclosed processor does not provide an optimum solution for all applications.

Accordingly, there is a need for further innovations in digital signal processor architecture and performance.

### SUMMARY OF THE INVENTION

According to a first aspect of the invention, a digital signal processor is provided. The digital signal processor comprises an instruction fetch unit for fetching and decoding instructions, a first execution unit having a first number of pipeline stages for executing instructions of a first instruction type, and a second execution unit having a second number of pipeline stages for executing instructions of a second instruction type, wherein the second number of pipeline stages is greater than the first number of pipeline stages. Instructions of the first instruction type are directed to the first execution unit, and instructions of the second instruction type are directed to the second execution unit.

The first execution unit may comprise a microcontroller execution unit, and the instructions of the first instruction type may comprise microcontroller instructions. The second execution unit may comprise a digital signal processor execution unit, and the instructions of the second instruction type may comprise digital signal processor instructions.

The digital signal processor may further comprise a register file associated with the first and second execution units, a data cache, a memory, and a control unit. The control unit may load data from the data cache to the register file in response to instructions of the first instruction type and may load data from the memory to the register file in response to instructions of the second instruction type. In a preferred embodiment, the memory comprises a plurality of pipeline stages and is configured to permit at least two independent accesses per cycle. The control unit may further include a skid buffer for holding instructions during loading of data from the memory to the register file.

The data cache may comprise a level one memory in a memory hierarchy, and the memory may comprise a level two memory in the memory hierarchy. The digital signal processor may further comprise a data cache controller for loading data from the memory to the data cache in response to a data cache miss.

According to another aspect of the invention, a digital signal processor is provided. The digital signal processor comprises an instruction fetch unit for fetching and decoding instructions, a data cache, a memory, an execution unit, including a register file, for executing the instructions, and a load control unit for loading data from the data cache to the register file in response to instructions of a first instruction type and for loading data from the memory to the register file in response to instructions of a second instruction type.

The instructions of the first instruction type may comprise microcontroller instructions, and the instructions of the second instruction type may comprise digital signal processor instructions. Preferably, the memory comprises a plurality of pipeline stages and is configured to permit at least two independent accesses per cycle. The load control unit may include a skid buffer for holding instructions during loading of data from the memory to the register file. The execution unit may comprise a microcontroller execution unit having a first number of pipeline stages for executing the microcontroller instructions and a digital signal processor execution unit having a second number of pipeline stages for executing the digital signal processor instructions.

According to a further aspect of the invention, a method is provided for executing instructions in a digital signal processor. The method comprises the steps of executing instructions of a first instruction type in a first execution unit having a first number of pipeline stages, and executing instructions of a second instruction type in a second execution unit having a second number of pipeline stages, wherein the second number of pipeline stages is greater than the first number of pipeline stages.

According to a further aspect of the invention, a method is provided for loading data in a digital signal processor. The method comprises the steps of providing a relatively small capacity data cache, a relatively large capacity memory and an execution unit, including a register file, for executing instructions, loading data from the data cache to the register file in response to instructions of a first instruction type, and loading data from the memory to the register file in response to instructions of a second instruction type.

### BRIEF DESCRIPTION OF THE DRAWINGS

For a better understanding of the present invention, reference is made to the accompanying drawings, which are incorporated herein by reference and in which:

FIG. 1 is a block diagram of a digital signal processor in accordance with an embodiment of the invention;

FIG. 2A is a schematic diagram that illustrates a pipeline configuration for execution of a microcontroller instruction;

FIG. 2B is a schematic diagram that illustrates a pipeline configuration for execution of a DSP instruction with no memory access;

FIG. 2C is a schematic diagram that illustrates a pipeline configuration for execution of a DSP instruction with memory access;

FIG. 3 is a block diagram of the digital signal processor of FIG. 1, showing major components of each pipeline unit;

FIG. 4 is a functional block diagram of an embodiment of a load control unit for controlling routing of data addresses and instructions according to the type of instruction being executed; and

FIG. 5 is a more detailed block diagram of the level 2 memory.

### DETAILED DESCRIPTION

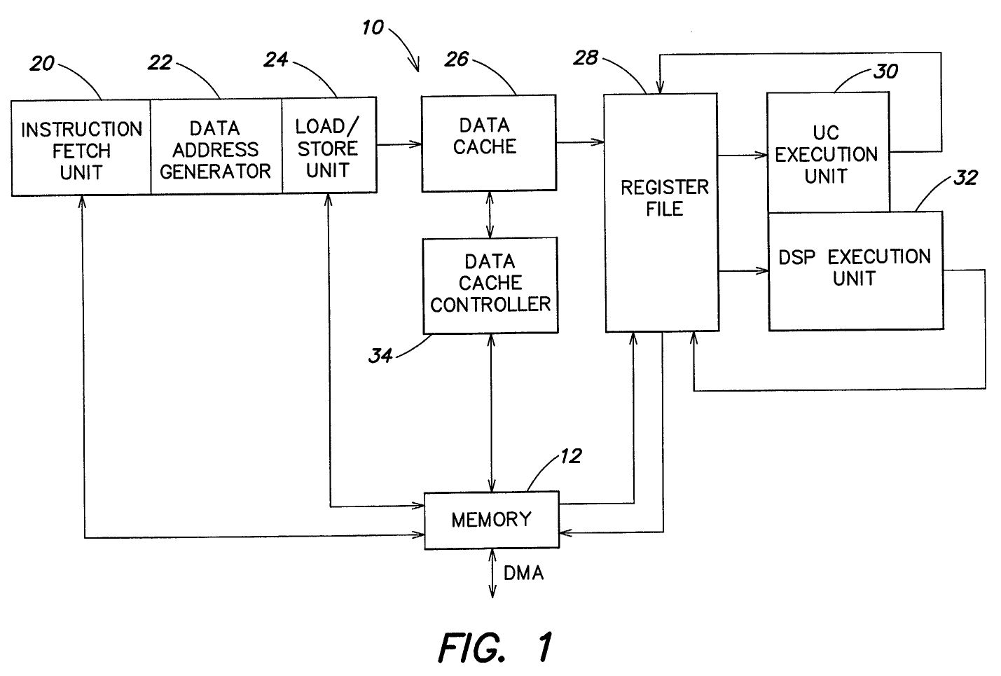

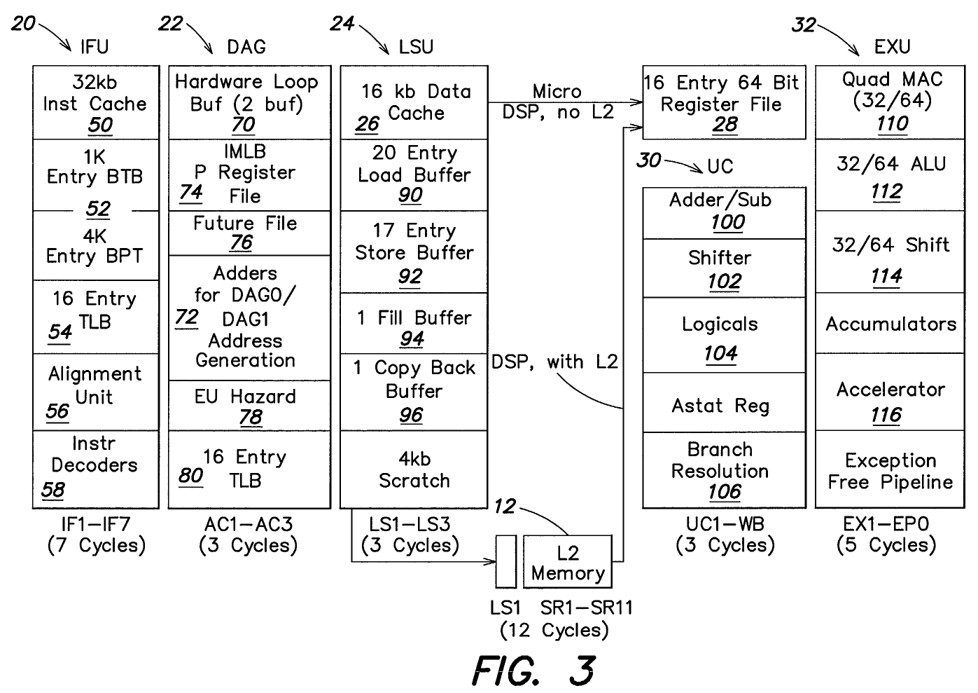

A block diagram of an embodiment of a digital signal processor in accordance with the invention is shown in FIGS. 1 and 3. The digital signal processor includes a computation core 10 and a memory 12. The computation core 10 is the central processor of the DSP. Both the core 10 and the memory 12 are pipelined, as described below. Core 10 includes an instruction fetch unit 20, a data address generator 22, a load/store unit 24, a data cache 26, a register file 28, a microcontroller execution unit 30, a DSP execution unit 32 and a data cache controller 34.

Instruction fetch unit 20 may include a 32 k byte instruction cache 50, branch prediction circuitry 52, a TLB (translation lookaside buffer) 54, an instruction alignment unit 56 and an instruction decoder 58. In instruction fetch unit 20, program instructions are fetched from the instruction cache 50 and are decoded by the instruction decoder 58. In the event of an instruction cache miss, the requested instruction is accessed in memory 12. Instructions may be placed in an instruction queue and subsequently decoded by the instruction decoder 58.

The data address generator 22 may include loop buffers 70 and adders 72 for data address generation in program loops. Virtual addresses are translated to physical addresses in data address generator 22. Data address generator 22 may also include a P register file 74, a future file 76, hazard detection circuitry 78 and a TLB 80.

Load/store unit 24 controls access to data cache 26 and memory 12. Load/store unit 24 may include a load buffer 90, a store buffer 92, a fill buffer 94 and a copyback buffer 96. The operations of the load/store unit 24 depend on instruction type, as described below. In the case of a microcontroller instruction or other instruction which requires access to data cache 26, the physical address is routed to data cache 26, the tag arrays of data cache 26 are accessed and the accessed data is output, as required by the instruction. Data cache controller 34 controls transfer of data between data cache 26 and memory 12. Instructions which do not require memory access may obtain operands from register file 28. In the case of a DSP instruction with memory access, the DSP instruction is placed in a skid buffer, and two memory accesses to memory 12 are initiated. Multiple DSP instructions can be placed in the skid buffer, and two memory accesses can be initiated on each cycle. The data from memory 12 is output to register file 28 for instruction execution. In a preferred embodiment, register file 28 has sixteen entries of 64 bits each and has four write ports and four read ports.

Microcontroller execution unit 30 may include an adder/subtractor 100, a shifter 102, circuitry 104 for logical operations and branch resolution circuitry 106. DSP execution unit 32 may include quad 32/64-bit multiplier/accumulators 110, a 32/64-bit ALU 112, a 32/64-bit shifter 114, an accelerator 116 for high speed execution of specific instructions and result formatting circuitry. The results of the microcontroller execution unit 30 and the DSP execution unit 32 are written back to register file 28. The final results may be written from register file 28 to memory 12.

The computation core 10 preferably has a pipelined architecture. The pipelined architecture is a well-known architecture wherein the core includes series-connected stages that operate synchronously, and instruction execution is divided into a series of operations performed in successive pipeline stages in successive clock cycles. Thus, for example, a first stage may perform instruction fetch, a second stage may perform instruction decoding, a third stage may perform data address generation, a fourth stage may perform data memory access and a fifth stage may perform the specified computation. An advantage of the pipelined architecture is increased operating speed, since multiple instructions may be in process simultaneously, with different instructions being in different states of completion.

The memory of the digital signal processor has a hierarchical organization. The instruction cache 50 and the data cache 26 are level 1 memories, and memory 12 is a level 2 memory. The level 1 memories are characterized by low latency and relatively small capacities. By contrast, level 2 memory 12 is characterized by high capacity and relatively high latency. In the event of a cache miss, the level 2 memory is accessed.

Memory 12 is functionally connected to load/store unit 24 for processing load and store requests in connection with program execution. Memory 12 is also connected via data cache controller 34 to data cache 26 for transferring data to and from data cache 26 and is connected via an instruction cache controller to instruction cache 50 for transferring data to and from instruction cache 50. Accessed data is loaded from memory 12 to register file 28, and results are written back from register file 28 to memory 12. Memory 12 may further include a DMA port for DMA transfers to and from an external source. Memory 12 is preferably pipelined for high speed operation and, in one example, has a capacity of 10 megabits.

As described below, DSP performance may be enhanced by controlling operation such that certain instruction types access data cache 26, whereas other instruction types directly access level 2 memory 12 without first accessing data cache 26. Instruction types that access data cache 26 are typically used in program segments where data access is characterized by temporal and/or spatial locality. Such program segments are likely to benefit from the use of a data cache. Microcontroller instructions typically fall into this category. Instruction types that directly access level 2 memory 12 are typically used in program segments where data access is not characterized by temporal or spatial locality. Such program segments are unlikely to benefit from the use of a data cache. DSP instructions typically fall into this category. To achieve the desired performance, level 2 memory 12 is preferably capable of high speed operation and may be pipelined. Further, level 2 memory 12 may be configured to provide two or more data words per cycle, since DSP instructions may require two or more operands. In one embodiment, data cache 26 has a capacity of 16 k bytes, and level 2 memory 12 has a capacity of 10 megabits.

One way to increase the operating speed of a processor is to increase the pipeline depth, i.e., the number of pipeline stages. Instruction execution is divided into more suboperations which are performed simultaneously in different stages. This increases the likelihood of completing at least one instruction per clock cycle as the clock frequency is increased. One drawback of this approach is that a large performance penalty is incurred when it is necessary to flush the pipeline, as for example in the event of a branch misprediction. Nonetheless, deeply pipelined processors with careful attention to the associated drawbacks provide high performance.

A preferred pipeline architecture is now described with reference to FIG. 1. With respect to pipeline operation, data cache 26 may be considered as part of the load/store function. Similarly, register file 28 may be considered as part of the execution function. In one embodiment, instruction fetch unit 20 has seven stages, data address generator 22 has three stages, and the combination of load/store unit 24 and data cache 26 has three stages. The combination of register file 28 and microcontroller execution unit 30 has three stages, and the combination of register file 28 and DSP execution unit 32 has eight stages. In addition, memory 12 is pipelined and has eleven stages in this embodiment. The number of stages defines the number of clock cycles required for an instruction to be completed in a particular unit. However, as noted above, multiple instructions may be in various stages of completion simultaneously. Thus, for example, seven-stage instruction fetch unit 20 may have seven instructions in different stages of completion on any given clock cycle.

As described above, the digital signal processor is required to execute instructions of different types, which have very different data requirements. Microcontroller instructions typically benefit from the use of a data cache, because the data requirements for a typical program segment are characterized by spatial and temporal locality. That is, when a program segment accesses a particular memory location, the same program segment is likely to access the same memory location again within a short time (temporal locality) or to access a nearby memory location (spatial locality). Thus, the data in a cache line is likely to re reused, and performance is likely to be enhanced by using a data cache in the case of microcontroller instructions. However, the spatial and temporal locality that is characteristic of microcontroller instructions typically is not characteristic of DSP instructions. DSP instructions may involve a series of operations on a large data set in which there is little or no reuse of the data. Thus, a data cache may in fact degrade performance in executing DSP instructions, since cache misses may occur frequently. When a cache miss occurs, the required data must be loaded from level 2 memory, and a performance penalty is incurred.

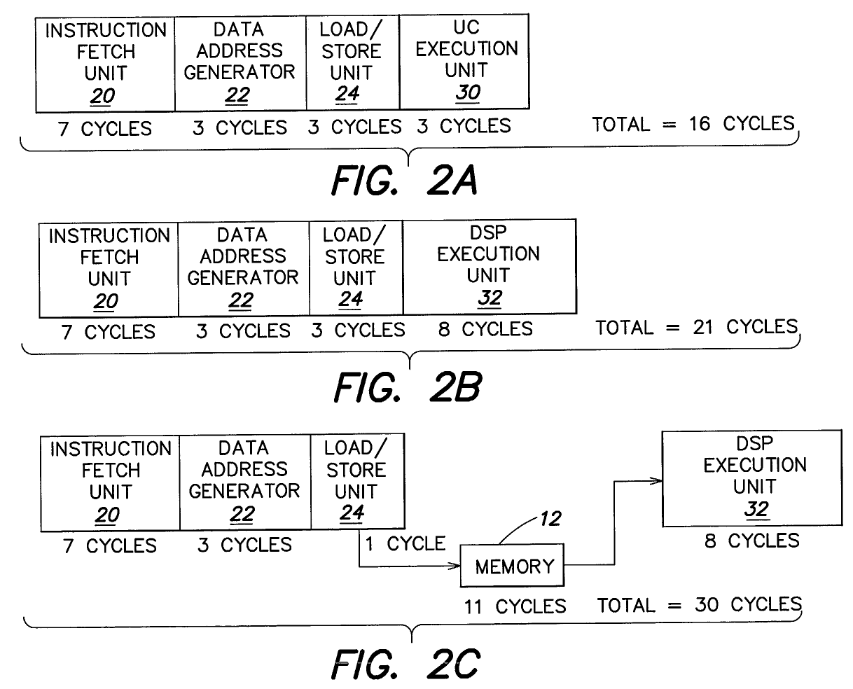

Referring now to FIGS. 2A-2C, the execution of three instruction types in the digital signal processor of FIG. 1 is illustrated. The pipeline configuration for execution of a microcontroller instruction is illustrated in FIG. 2A. The microcontroller instruction requires a total of sixteen processor cycles, with seven cycles (IF1-IF7) for operations by the instruction fetch unit 20, three cycles (AC1-AC3) for operations by the data address generator 22, three cycles (LS1-LS3) for operations by the load/store unit 24 and three cycles (UC1-WB) for operations by the microcontroller execution unit 30. The data for the microcontroller instruction is accessed by load/store unit 24 in data cache 26 and is loaded into register file 28. In the case of a data cache miss, the pipeline is stalled and additional cycles are required to access data in memory 12. The microcontroller execution unit 30 is relatively short (three cycles) because microcontroller instructions typically involve relatively simple computations and/or logical operations. The pipeline for execution of microcontroller instructions thus has a total length of sixteen cycles in this embodiment.

Referring to FIG. 2B, the pipeline configuration for execution of a DSP instruction with no memory access is shown. As in the case of a microcontroller instruction, the instruction fetch unit 20 requires seven cycles, the data address generator 22 requires three cycles and the load/store unit 24 requires three cycles. In DSP instructions of this type, the required operands may be present in the register file, and memory access is not required. DSP execution unit 32 has a length of eight cycles (UC1-WB and EX1-EPO), indicative of the more complex computations typically associated with DSP computations. The pipeline for execution of DSP instructions with no memory access has a total length of twenty-one cycles.

Referring to FIG. 2C, the pipeline configuration for execution of a DSP instruction with memory access is shown. As in the case of microcontroller instructions and DSP instructions with no memory access, the instruction fetch unit 20 requires seven cycles, and the data address generator 22 requires three cycles. The load/store unit 24 initiates an access to memory 12. As described below, the memory access for a DSP instruction preferably involves two data accesses to provide two operands for the DSP instruction. The level 2 memory 12 in this embodiment requires eleven cycles (SR1-SR11) for a dual access, and the load/store unit 24 requires one cycle (LS1) to initiate the dual memory access. Thus, the total memory access requires twelve cycles. The accessed data is placed in the register file 28 (FIG. 1) and is used by the DSP execution unit 32. The DSP instruction that requires memory access is placed in the load buffer and is supplied to the DSP execution unit 32 when the accessed data reaches the DSP execution unit 32.

As is apparent in FIG. 2C, a DSP instruction requiring memory access incurs a latency of twelve cycles to complete the memory access. However, because of the nature of DSP computations, the adverse impact on performance is minimal. In particular, DSP computations typically involve repetitive computations on a large data set. In this common case, the memory latency is incurred only for the first DSP instruction in a series of instructions. After the first instruction, memory 12 provides two operands per cycle.

As indicated above, a memory hierarchy is utilized. In particular, data cache 26 serves as a level 1 memory, and memory 12 serves as a level 2 data memory. As known in the art, higher levels in the memory hierarchy typically are characterized by low latency and low capacity. In the embodiment of FIG. 1, data cache 26 accesses level 2 memory 12 in the case of a cache miss. However, DSP instructions requiring memory access do not access the data cache 26 and thus do not incur the overhead associated with a cache miss. Instead, DSP instructions requiring memory access directly access level 2 memory 12. The latency otherwise associated with lower level memories is avoided by configuring level 2 memory 12 as a highly pipelined memory that is capable of providing two data items per cycle. In particular, on every cycle two memory accesses can be started and two data items can be provided to DSP execution unit 32. So far as the programmer is concerned, two 64-bit data items are being received by DSP execution unit 32 on every cycle.

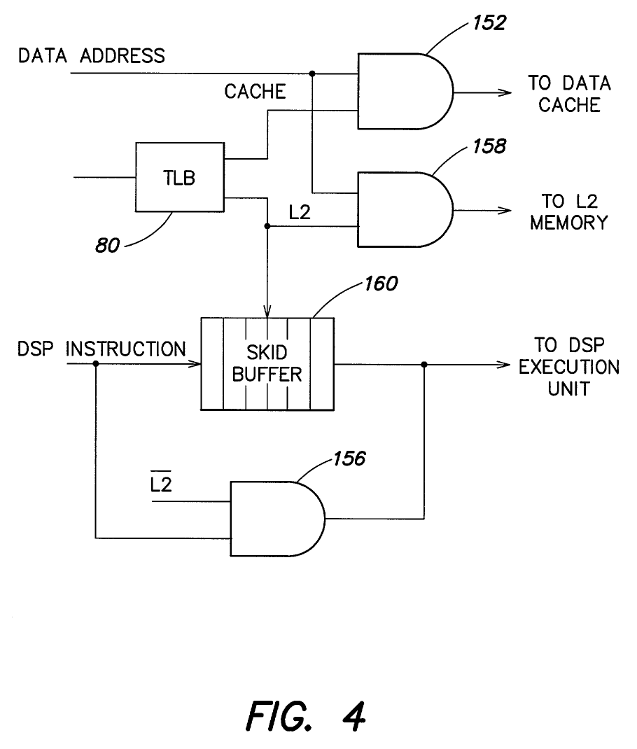

A functional block diagram of an embodiment of a load control unit for controlling routing of data addresses and instructions according to the type of instruction being executed is shown in FIG. 4. The load control unit may be located in load/store unit 24 (FIG. 1) or another unit, or may be divided between units. The TLB 80 receives the data address and determines whether the operand is located in data cache 26 (CACHE output asserted) or in level 2 memory 12 (L2 output asserted).

In the case of a cache access, typically associated with a microcontroller instruction, a logic element 152 routes the data address to data cache 26 and the instruction is sent to microcontroller execution unit 30. The data specified by the data address is accessed in data cache 26 and is loaded into register file 28 for use in execution of the microcontroller instruction.

In the case of a DSP instruction with no memory access, the L2 output of TLB 80 is not asserted. A logic element 156 routes the DSP instruction to DSP execution unit 32. In this case, the required operands may be available in register file 28, and memory access is not required.

In the case of a level 2 memory access, typically associated with a DSP instruction, a logic element 158 routes the data address to level 2 memory 12, and the DSP instruction is loaded into a skid buffer 160. In a preferred embodiment, two data addresses are supplied to level 2 memory 12, so that two operands can be provided for execution of the DSP instruction. When the access to memory 12 is complete, the accessed data words are loaded into register file 28 and the corresponding instruction is forwarded from skid buffer 160 to DSP execution unit 32.

Skid buffer 160 permits the instruction to be held for a time that corresponds to the memory latency, so that the instruction and the required operands reach DSP execution unit 32 together. Skid buffer 160 also permits the level 2 memory access to proceed without stalling the DSP core 10. Absence of a skid buffer would result in the level 2 memory access stalling the DSP core 10. Two accesses would go to level 2 memory 12, and then the DSP core 10 would stall and wait for the results. Then, two more accesses would be sent to level 2 memory 12, and so on. With skid buffer 160, DSP core 10 can issue two level 2 memory accesses every cycle and receive two results every cycle.

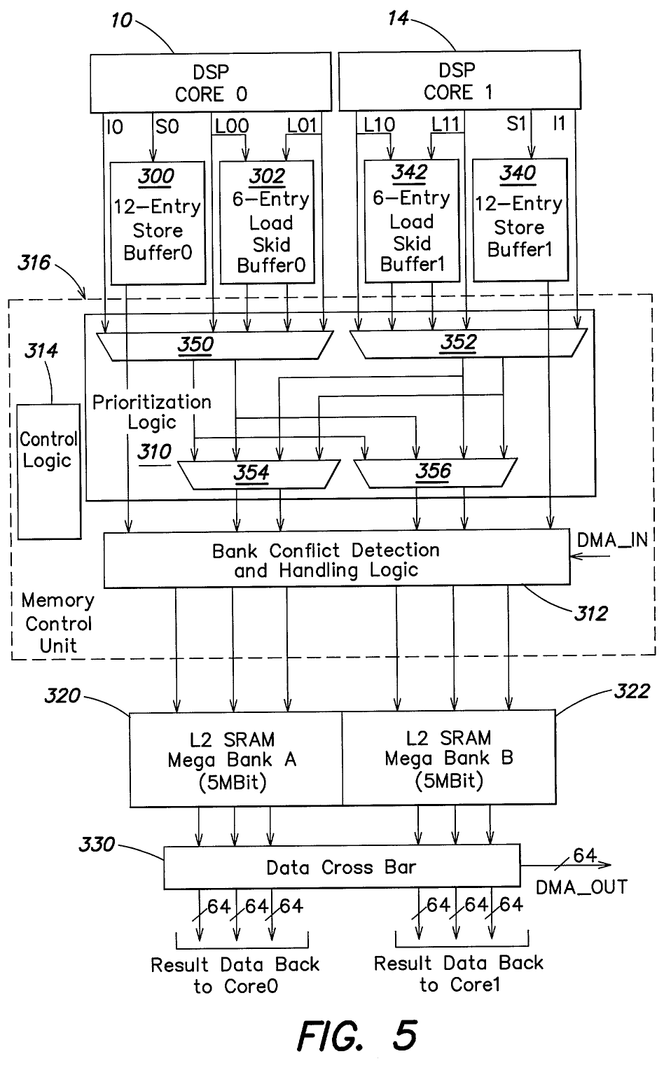

A block diagram of an embodiment of level 2 memory 12 is shown in FIG. 5. In the embodiment of FIG. 5, memory 12 may be accessed by DSP core 10 and a second DSP core 14. However, it will be understood that memory 12 may operate with a single DSP core, such as DSP core 10.

DSP core 10 communicates with memory 12 via load buses L00 and L01, a store bus S0 and an instruction bus IO. Memory 12 includes a store buffer 300, a load skid buffer 302, prioritization logic 310, bank conflict detection and handling logic 312, control logic 314, SRAM megabanks 320 and 322 and a data crossbar 330. Prioritization logic 310, bank conflict detection and handling logic 312 and control logic 314 constitute a memory control unit 316. In the case where the memory 12 operates with DSP core 14, memory 12 further includes a store buffer 340 and a load skid buffer 342.

Load buses L00 and L01 may be coupled to prioritization logic 310 and to load skid buffer 302. Load skid buffer 302 provides buffering of load requests in the event that the pipeline is stalled. The store bus SO is coupled through store buffer 300 to bank conflict detection and handling logic 312. Instruction bus IO is coupled to prioritization logic 310.

Prioritization logic 310 prioritizes memory access requests according to priorities that are predetermined or are programmable. In one embodiment, a DMA request has highest priority, a load from skid buffer 302 has second priority, a load from DSP core 10 has third priority, an instruction request from DSP core 10 has fourth priority and a store request has lowest priority. It will be understood that different priorities may be utilized to achieve a desired result.

The bank conflict detection and handling logic 312 determines conflicts among memory access requests. In one embodiment, each of megabanks 320 and 322 includes five superbanks and can handle two load requests, one store request and one DMA request in parallel, provided that the access requests are addressed to different superbanks. In the event of a bank conflict, i.e. two access requests to the same superbank, the conflicting requests are pipelined one behind the other in the memory and a stall condition is generated. A stall signal is forwarded to the DSP core 10, whereby the DSP core 10 is notified to expect the result later.

In one embodiment, each of megabanks 320 and 322 has a size of 5 megabits, for a total memory size of 10 megabits, and can run at a clock frequency greater than 1 gigahertz. Each megabank includes five superbanks, each having a size of 1 megabits, so that multiple access requests can be serviced simultaneously by different superbanks. This permits two load requests to be started on each cycle and two load results to be provided to register file 28 on each cycle. Thus, two 64-bit load results can be obtained on each cycle. Data crossbar 330 routes data from megabanks 320 and 322 to DSP core 10, DSP core 14 and a DMA requester in accordance with control signals derived from the instruction being executed.

As noted above, level 2 memory 12 preferably has a pipeline configuration. In one embodiment, memory 12 has eleven stages and thus requires eleven cycles to service a load request. However, the eleven stage pipeline may process eleven access requests simultaneously and may supply two load results per clock cycle to register file 28 (FIG. 1).

The memory access is initiated in the LS1 stage of load/store unit 24. Memory 12 includes stages SR1 through SR11. Stage SR1 involves routing delay to the edge of memory 12 and SRAM base address compare. Stage SR2 involves prioritization of requests and bank address decode. Stage SR3 involves bank conflict detection, bank select generation and address and control signals present in registers at the edge of the megabank. Stage SR4 involves address routing to all the superbanks.

Stage SR5 involves delay through a 4:1 address mux at the edge of the superbank for selection of load 0, load 1, store or DMA address buses and address routing to minibanks within the superbanks. Stage SR6 involves row address decoding and generation of quadrant enable. Stage SR7 involves reading memory arrays, read column multiplexing and data present in registers at the edge of the quadrant. Stage SR8 involves quadrant multiplexing, minibank multiplexing and routing data across minibanks. Data is present in a register at the edge of the superbank. Stage SR9 involves routing across the five superbanks, superbank multiplexing and data present in a register at the edge of the megabank. Stage SR10 involves routing across the two minibanks and megabank multiplexing. Stage SR11 involves transport to the edge of the DSP core 10.

Data is multiplexed to the register file 28 in stage UC1. The corresponding instruction is read out of skid buffer 160 (FIG. 4) during stage SR8 and is advanced through stages LS1, LS2 and LS3 of load/store unit 24 simultaneously with the load request being advanced through stages SR9, SR10 and SR11, respectively, of memory 12. Thus, the corresponding instruction reaches the DSP execution unit 32 when the accessed data is present in register file 28.

While there have been shown and described what are at present considered the preferred embodiments of the present invention, it will be obvious to those skilled in the art that various changes and modifications may be made therein without departing from the scope of the invention as defined by the appended claims.

1. A digital signal processor comprising:
an instruction fetch unit for fetching and decoding instructions;
a first execution unit having a first number of pipeline stages for executing instructions of a first instruction type; and
a second execution unit having a second number of pipeline stages for executing instructions of a second instruction type, wherein the second number of pipeline stages is greater than the first number of pipeline stages.

2. A digital signal processor as defined in claim 1 wherein said first execution unit comprises a microcontroller execution unit and wherein the instructions of the first instruction type comprise microcontroller instructions.

3. A digital signal processor as defined in claim 2 wherein said second execution unit comprises a digital signal processor execution unit and wherein the instructions of the second instruction type comprise digital signal processor instructions.

4. A digital signal processor as defined in claim 1 further comprising a register file associated with said first and second execution units, a data cache, a memory, and a control unit for loading data from said data cache to said register file in response to instructions of the first instruction type and for loading data from said memory to said register file in response to instructions of the second instruction type.

5. A digital signal processor as defined in claim 4 wherein said memory comprises a plurality of pipeline stages.

6. A digital signal processor as defined in claim 5 wherein said memory is configured to permit at least two independent accesses per cycle.

7. A digital signal processor as defined in claim 5 wherein said control unit includes a skid buffer for holding one or more instructions during loading of data from said memory to said register file.

8. A digital signal processor as defined in claim 5 wherein said memory has a capacity of about 10 megabits.

9. A digital signal processor as defined in claim 4 wherein said data cache comprises a level one memory in a memory hierarchy and said memory comprises a level two memory in the memory hierarchy.

10. A digital signal processor as defined in claim 9 further comprising a data cache controller for loading data from said memory to said data cache in response to a data cache miss.

11. A digital signal processor comprising:
an instruction fetch unit for fetching and decoding instructions;
a data cache;
a memory;
an execution unit, including a register file, for executing the instructions; and
a load control unit for loading data from said data cache to said register file in response to instructions of a first instruction type and for loading data from said memory to said register file in response to instructions of a second instruction type.

12. A digital signal processor as defined in claim 11 wherein instructions of the first instruction type comprise microcontroller instructions and wherein instructions of the second instruction type comprise digital signal processor instructions.

13. A digital signal processor as defined in claim 12 wherein said memory comprises a plurality of pipeline stages.

14. A digital signal processor as defined in claim 13 wherein said memory is configured to permit at least two independent accesses per cycle.

15. A digital signal processor as defined in claim 13 wherein said control unit includes a skid buffer for holding instructions during loading of data from said memory to said register file.

16. A digital signal processor as defined in claim 12 wherein said memory has a capacity of about 10 megabits.

17. A digital signal processor as defined in claim 12 wherein said execution unit comprises a first execution unit having a first number of pipeline stages for executing the microcontroller instructions and a second execution unit having a second number of pipeline stages for executing the digital signal processor instructions.

18. A digital signal processor as defined in claim 17 wherein said second execution unit has a greater number of pipeline stages than said first execution unit.

19. A digital signal processor as defined in claim 11 wherein said data cache comprises a level one memory in a memory hierarchy and said memory comprises a level two memory in the memory hierarchy.

20. A digital signal processor as defined in claim 19 further comprising a data cache controller for loading data from said memory to said data cache in response to a data cache miss.

21. A digital signal processor as defined in claim 11 wherein said data cache has a relatively small capacity and said memory has a relatively large capacity.

22. A method for executing instructions in a digital signal processor, comprising the steps of:
executing instructions of a first instruction type in a first execution unit having a first number of pipeline stages; and
executing instructions of a second instruction type in a second execution unit having a second number of pipeline stages, wherein the second number of pipeline stages is greater than the first number of pipeline stages.

23. A method as defined in claim 22 further comprising the steps of supplying data from a relatively small capacity data cache to the first execution unit and supplying data from a relatively large capacity memory to the second execution unit.

24. A method as defined in claim 22 wherein the step of executing instructions of a first instruction type comprises executing microcontroller instructions and wherein the step of executing instructions of a second instruction type comprises executing digital signal processor instructions

25. A method for loading data in a digital signal processor, comprising the steps of:
providing a relatively small capacity data cache, a relatively large capacity memory, and an execution unit, including a register file, for executing instructions;
loading data from the data cache to the register file in response to instructions of a first instruction type; and
loading data from the memory to the register file in response to instructions of a second instruction type.

26. A method as defined in claim 25 wherein instructions of the first instruction type comprise microcontroller instructions and wherein instructions of the second instruction type comprise digital signal processor instructions.

27. A method as defined in claim 25 further comprising the steps of holding in a skid buffer load instructions of the second instruction type when the corresponding data is being loaded from the memory to the register file.

28. A method as defined in claim 25 further comprising the step of loading data from said memory to said data cache in response to a data cache miss.

29. A method as defined in claim 25 wherein said execution unit comprises a first execution unit having a first number of pipeline stages and a second execution unit having a second number of pipeline stages, wherein the second number of pipeline stages is greater than the first number of pipeline stages, further comprising the steps of executing instructions of the first instruction type in said first execution unit and executing instructions of the second instruction type in said second execution unit.
